(19) United States
(12) Patent Application Publication
(10) Pub. No.: US 2009/0015681 A1
(43) Pub. Date: Jan. 15, 2009

(54) MULTIPOINT AUTOFOCUS FOR ADJUSTING DEPTH OF FIELD

(75) Inventor: Peter Pipkorn, Lund (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/776,950

(22) Filed: Jul. 12, 2007

(51) Int. Cl. H04N 5/232

(52) U.S. Cl. 348/208.12; 348/E05.045

(57) ABSTRACT

A device may include logic to capture an image, logic to detect a plurality of faces in the image, logic to calculate a distance associated with each face, logic to calculate a depth of field based on the distance associated with each face, and logic to calculate focus and exposure settings to capture the image based on the depth of field associated with the plurality of faces.

### BACKGROUND

The proliferation of devices, such as portable devices, has grown tremendously within recent years. Some of these devices may include an image capturing component, such as a camera. The camera may be able to capture pictures and/or video. However, the sophistication of the camera features provided to a user may vary depending on the device. For example, some devices may allow a user to set certain camera settings, while other devices may provide these settings automatically. Nevertheless, any user that utilizes this type of device may be confronted with some limitations associated with taking a picture or video. That is, despite the sophistication of camera features, a user may be unable to capture a clear image of multiple objects or persons within an image frame.

### SUMMARY

According to one aspect, a device may include logic to capture an image, logic to detect a plurality of faces in the image, logic to calculate a distance associated with each face, logic to calculate a depth of field based on the distance associated with each face, and logic to calculate focus and exposure settings to capture the image based on the depth of field associated with the plurality of faces.

Additionally, the logic to calculate a distance may include logic to determine coordinate information for each face in the image, and logic to calculate a distance associated with each face based on the coordinate information of each face in the image.

Additionally, the logic to calculate a distance may include logic to calculate a distance associated with each face based on a focus setting corresponding to each face.

Additionally, the logic to calculate a depth of field may include logic to calculate a depth of field based on a distance corresponding to a nearest face and a distance corresponding to a farthest face.

Additionally, the logic to calculate a depth of field may calculate a depth of field based on a difference distance between the nearest and the farthest faces.

Additionally, the logic to calculate focus and exposure settings may include logic to calculate a focus point based on the depth of field.

According to another aspect, a device may include a camera to capture an image, logic to detect and track faces in the image, logic to determine a distance associated with each face based on respective camera settings for each face, logic to calculate a depth of field based on the distances associated with the faces, and logic to determine focus and exposure settings to capture the image based on the depth of field and the respective camera settings for each face.

Additionally, the camera settings for each face may be based on sensor size and pixel size of an image sensor.

Additionally, the camera settings for each face may include a focus point setting.

Additionally, the logic to determine focus and exposure settings may include logic to calculate a focus point based on the depth of field.

Additionally, the logic to determine focus and exposure settings may include logic to calculate an aperture size that provides a depth of field to include each focusing point associated with each face.

Additionally, the logic to determine focus and exposure settings may include logic to calculate a focus point so that the depth of field includes each focusing point associated with each face.

Additionally, the logic to determine focus and exposure settings may include logic to adjust the depth of field based on lighting conditions and characteristics of a camera component.

According to still another aspect, a device may include an image capturing component to capture an image, an object recognition system to detect multiple objects of like classification in the image, logic to determine a distance associated with each object of like classification based on auto-focusing on each object, logic to calculate a depth of field based on the distances of the objects, and logic to determine camera settings to capture the image based on the depth of field.

Additionally, the object recognition system may detect and track at least one of human faces, plants, or animals.

Additionally, the logic to determine camera settings may include logic to determine a focus point based on the depth of field.

Additionally, the logic to determine a distance may include logic to determine coordinate information for each object in the image, and logic to calculate a distance associated with each object based on the coordinate information of an object in the image.

According to yet another aspect, a device may include means for capturing an image, means for detecting and tracking faces in the image, means for calculating a distance between the device and each face in the image, means for calculating a depth of field based on each distance associated with each face, means for calculating a focus point based on the calculated depth of field, and means for calculating camera settings for capturing the image of faces based on the calculated depth of field and the calculated focus point.

Additionally, the means for calculating a depth of field may include means for determining a difference distance between a distance associated with a nearest face and a distance associated with a farthest face.

According to still another aspect, a method may include identifying face data regions in an image that correspond to human faces to be captured by a camera, determining a distance between each human face and the camera, calculating a depth of field based on the distances associated with the human faces, and calculating a focus point to capture the human faces based on the calculated depth of field.

Additionally, the calculating the depth of field may include calculating a difference distance based on a distance of a human face that is closest to the camera and a distance of a human face that is farthest from the camera.

### BRIEF DESCRIPTION OF THE DRAWINGS

The accompanying drawings, which are incorporated in and constitute a part of this specification, illustrate exemplary embodiments described herein and, together with the description, explain these exemplary embodiments. In the drawings:

FIG. 1(a) and FIG. 1(b) are diagrams illustrating exemplary operations associated with multipoint autofocus for adjusting depth of field;

FIG. 1(c) is a diagram illustrating a front view of external components of an exemplary device having multipoint autofocus for adjusting depth of field capability;

FIG. 1(d) is a diagram illustrating a rear view of external components of the exemplary device depicted in FIG. 1(c);

FIG. 2 is a diagram illustrating internal components of the exemplary device depicted in FIG. 1(c);

FIG. 3(a) is a diagram illustrating components of the exemplary camera depicted in FIG. 1(d);

FIG. 3(b) is a diagram illustrating an exemplary face detection and tracking system of the exemplary camera depicted in FIG. 1(d);

FIG. 4 is a flow diagram of exemplary operations for performing multipoint autofocus for adjusting depth of field;

FIG. 5(a) is a diagram illustrating a front view of external components of another exemplary device having multipoint autofocus for adjusting depth of field capability;

FIG. 5(b) is a diagram illustrating a rear view of external components of the exemplary device depicted in FIG. 5(a); and

FIGS. 6(a)-6(b) are diagrams illustrating exemplary operations for performing multipoint autofocus for adjusting depth of field.

### DETAILED DESCRIPTION

The following detailed description refers to the accompanying drawings. The same reference numbers in different drawings may identify the same or similar elements. Also, the following description does not limit the invention. The term “image,” as used herein, may include a digital or an analog representation of visual information (e.g., a picture, a video, an animation, etc.). The term “subject,” as used herein, may include any person, place, and/or thing capable of being captured as an image. The term “image capturing component,” as used herein may include any device capable of recording and/or storing an image. For example, an image capturing component may include a camera and/or a video camera.

### Overview

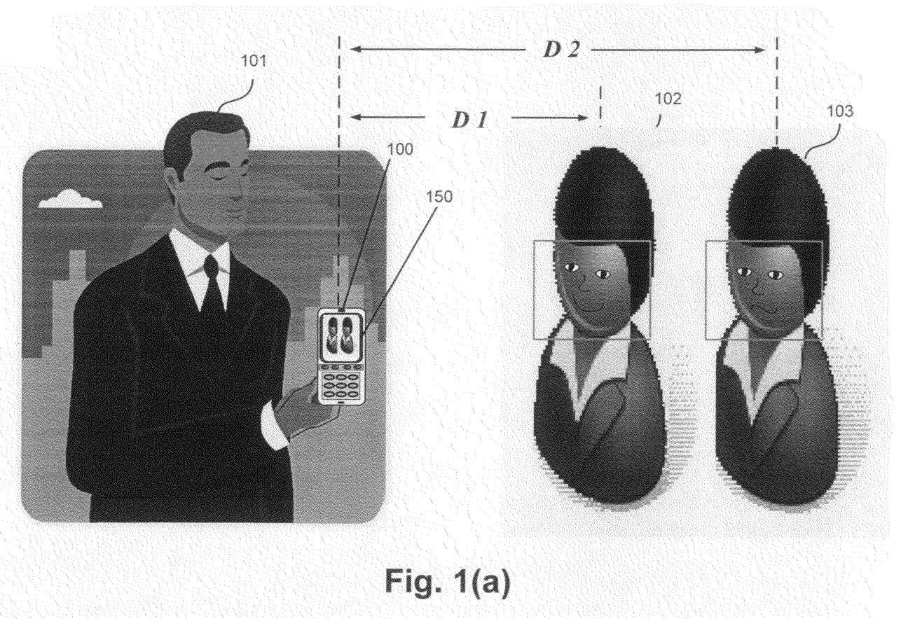

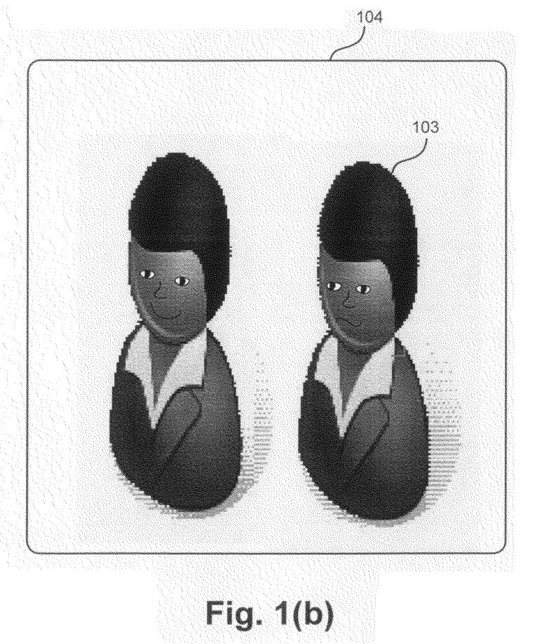

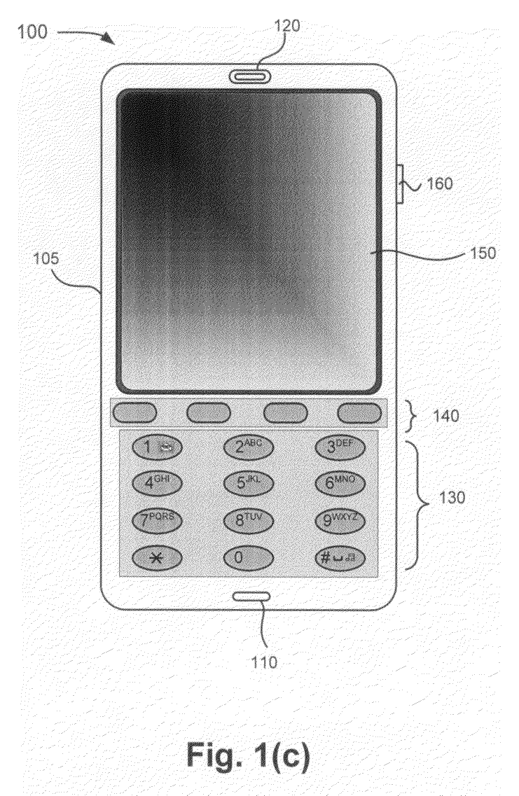

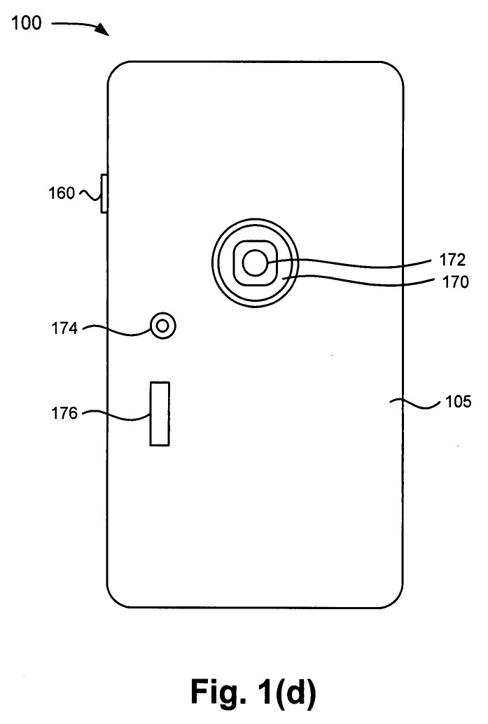

Implementations described herein may provide a device having an image capturing component with multipoint autofocus for adjusting depth of field (DOF). FIG. 1(a)-FIG. 1(b) are diagrams illustrating exemplary operations associated with multipoint autofocus for adjusting DOF. As illustrated in FIG. 1(a), a person 101 may have a device 100 that includes a display 150 and an image capturing component, such as a camera. Person 101 may be taking a picture (or a video) of subjects 102 and 103 using device 100. Display 150 may operate as a viewfinder when person 101 operates the camera.

Device 100 may include face-detection and tracking capability to automatically detect face data regions of subjects 102 and 103 in an image. For discussion purposes only, FIG. 1(a) depicts exemplary face data regions as a square surrounding each face of subjects 102 and 103. Based on face data region information, device 100 may automatically calculate that subject 102 is a distance (D1) from device 100 and that subject 103 is a distance D2 from device 100.

Device 100 may automatically calculate camera settings for capturing an image of subjects 102 and 103 based on the distance information. For example, device 100 may determine a DOF based on calculating a difference of distance between distance D1 and distance D2. Device 100 may also calculate a focus point based on the camera settings associated with calculating distance D1 and distance D2. Thus, as illustrated in FIG. 1(b), despite the fact that subjects 102 and 103 are different distances from device 100, a user may capture a clear image 104 since the camera settings are automatically set in an optimal manner.

### Exemplary Device

FIG. 1(c) is a diagram illustrating a front view of external components of an exemplary device having multipoint autofocus for adjusting depth of field capability. As illustrated in FIG. 1(c), device 100 may include a housing 105, a microphone 110, a speaker 120, a keypad 130, function keys 140, a display 150, and a camera button 160.

Housing 105 may include a structure configured to contain components of device 100. For example, housing 105 may be formed from plastic and may be configured to support microphone 110, speaker 120, keypad 130, function keys 140, display 150, and camera button 160.

Microphone 110 may include any component capable of transducing air pressure waves to a corresponding electrical signal. For example, a user may speak into microphone 110 during a telephone call. Speaker 120 may include any component capable of transducing an electrical signal to a corresponding sound wave. For example, a user may listen to music through speaker 120.

Keypad 130 may include any component capable of providing input to device 100. Keypad 130 may include a standard telephone keypad. Keypad 130 may also include one or more special purpose keys. In one implementation, each key of keypad 130 may be, for example, a pushbutton. A user may utilize keypad 130 for entering information, such as text or a phone number, or activating a special function.

Function keys 140 may include any component capable of providing input to device 100. Function keys 140 may include a key that permits a user to cause device 100 to perform one or more operations. The functionality associated with a key of function keys 140 may change depending on the mode of device 100. For example, function keys 140 may perform a variety of operations, such as placing a telephone call, playing various media, setting various camera features (e.g., focus, zoom, etc.) or accessing an application. Function keys 140 may include a key that provides a cursor function and a select function. In one implementation, each key of function keys 140 may be, for example, a pushbutton.

Display 150 may include any component capable of providing visual information. For example, in one implementation, display 150 may be a liquid crystal display (LCD). In another implementation, display 150 may be any one of other display technologies, such as a plasma display panel (PDP), a field emission display (FED), a thin film transistor (TFT) display, etc. Display 150 may be utilized to display, for example, text, image, and/or video information. Display 150 may also operate as a view finder, as will be described later. Camera button 160 may be a pushbutton that enables a user to take an image.

Since device 100 illustrated in FIG. 1(c) is exemplary in nature, device 100 is intended to be broadly interpreted to include any type of electronic device that includes an image capturing component. For example, device 100 may include a wireless phone, a personal digital assistant (PDA), a portable computer, a camera, or a wrist watch. In other instances, device 100 may include, for example, security devices or military devices. Accordingly, although FIG. 1(c) illustrates exemplary external components of device 100, in other implementations, device 100 may contain fewer, different, or additional external components than the external components depicted in FIG. 1(c). Additionally, or alternatively, one or more external components of device 100 may include the capabilities of one or more other external components of device 100. For example, display 150 may be an input component (e.g., a touch screen). Additionally, or alternatively, the external components may be arranged differently than the external components depicted in FIG. 1(c).

FIG. 1(d) is a diagram illustrating a rear view of external components of the exemplary device. As illustrated, in addition to the components previously described, device 100 may include a camera 170, a lens assembly 172, a proximity sensor 174, and a flash 176.

Camera 170 may include any component capable of capturing an image. Camera 170 may be a digital camera. Display 150 may operate as a view finder when a user of device 100 operates camera 170. Camera 170 may provide for automatic and/or manual adjustment of a camera setting. In one implementation, device 100 may include camera software that is displayable on display 150 to allow a user to adjust a camera setting. For example, a user may be able adjust a camera setting by operating function keys 140.

Lens assembly 172 may include any component capable of manipulating light so that an image may be captured. Lens assembly 172 may include a number of optical lens elements. The optical lens elements may be of different shapes (e.g., convex, biconvex, plano-convex, concave, etc.) and different distances of separation. An optical lens element may be made from glass, plastic (e.g., acrylic), or plexiglass. The optical lens may be multicoated (e.g., an antireflection coating or an ultraviolet (UV) coating) to minimize unwanted effects, such as lens flare and inaccurate color. In one implementation, lens assembly 172 may be permanently fixed to camera 170. In other implementations, lens assembly 172 may be interchangeable with other lenses having different optical characteristics. Lens assembly 172 may provide for a variable aperture size (e.g., adjustable f-number).

Proximity sensor 174 may include any component capable of collecting and providing distance information that may be used to enable camera 170 to capture an image properly. For example, proximity sensor 174 may include an infrared (IR) proximity sensor that allows camera 170 to compute the distance to an object, such as a human face, based on, for example, reflected IR strength, modulated IR, or triangulation. In another implementation, proximity sensor 174 may include an acoustic proximity sensor. The acoustic proximity sensor may include a timing circuit to measure echo return of ultrasonic sound waves.

Flash 176 may include any type of light-emitting component to provide illumination when camera 170 captures an image. For example, flash 176 may be a light-emitting diode (LED) flash (e.g., white LED) or a xenon flash. In another implementation, flash 176 may include a flash module.

Although FIG. 1(d) illustrates exemplary external components, in other implementations, device 100 may include fewer, additional, and/or different components than the exemplary external components depicted in FIG. 1(d). For example, in other implementations, camera 170 may be a film camera. Additionally, or alternatively, depending on device 100, flash 176 may be a portable flashgun. Additionally, or alternatively, device 100 may be a single-lens reflex camera. In still other implementations, one or more external components of device 100 may be arranged differently.

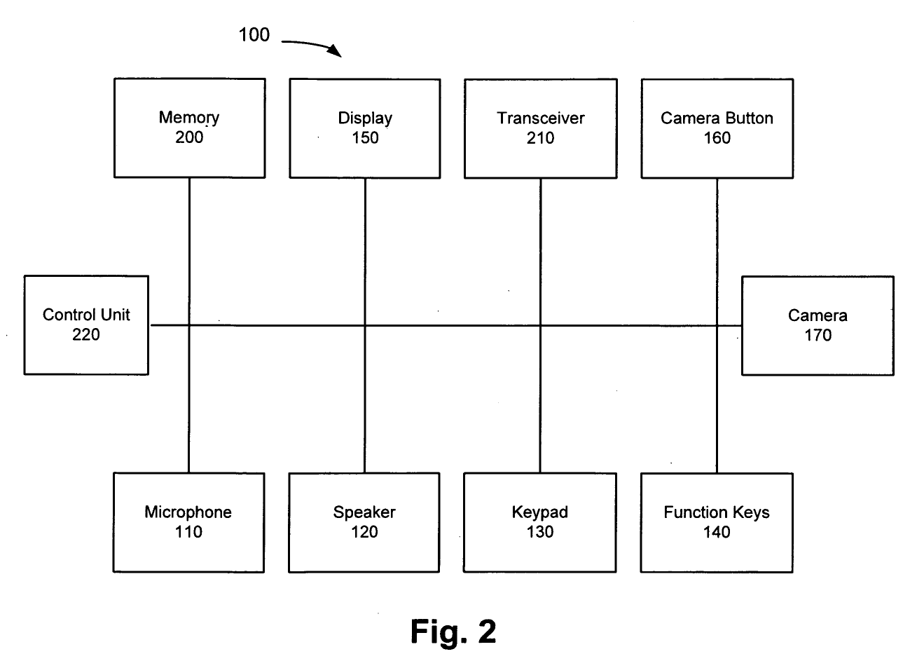

FIG. 2 is a diagram illustrating internal components of the exemplary device. As illustrated, device 100 may include microphone 110, speaker 120, keypad 130, function keys 140, display 150, camera button 160, camera 170, a memory 200, a transceiver 210, and a control unit 220. No further description of microphone 110, speaker 120, keypad 130, function keys 140, display 150, camera button 160, and camera 170 is provided with respect to FIG. 2.

Memory 200 may include any type of storing component to store data and instructions related to the operation and use of device 100. For example, memory 200 may include a memory component, such as a random access memory (RAM), a read only memory (ROM), and/or a programmable read only memory (PROM). Additionally, memory 200 may include a storage component, such as a magnetic storage component (e.g., a hard drive) or other type of computer-readable medium. Memory 200 may also include an external storing component, such as a Universal Serial Bus (USB) memory stick, a digital camera memory card, and/or a Subscriber Identity Module (SIM) card.

Transceiver 210 may include any component capable of transmitting and receiving information. For example, transceiver 210 may include a radio circuit that provides wireless communication with a network or another device.

Control unit 220 may include any logic that may interpret and execute instructions, and may control the overall operation of device 100. Logic, as used herein, may include hardware, software, and/or a combination of hardware and software. Control unit 220 may include, for example, a general-purpose processor, a microprocessor, a data processor, a co-processor, and/or a network processor. Control unit 220 may access instructions from memory 200, from other components of device 100, and/or from a source external to device 100 (e.g., a network or another device).

Control unit 220 may provide for different operational modes associated with device 100. Additionally, control unit 220 may operate in multiple modes simultaneously. For example, control unit 220 may operate in a camera mode, a walkman mode, and/or a telephone mode. For example, when in camera mode, face-detection and tracking logic may enable device 100 to detect and track multiple subjects (e.g., the presence and position of each subject's face) within an image to be captured. The face-detection and tracking capability of device 100 will be described in greater detail below.

Although FIG. 2 illustrates exemplary internal components, in other implementations, device 100 may include fewer, additional, and/or different components than the exemplary internal components depicted in FIG. 2. For example, in one implementation, device 100 may not include transceiver 210. In still other implementations, one or more internal components of device 100 may include the capabilities of one or more other components of device 100. For example, transceiver 210 and/or control unit 210 may include their own on-board memory 200.

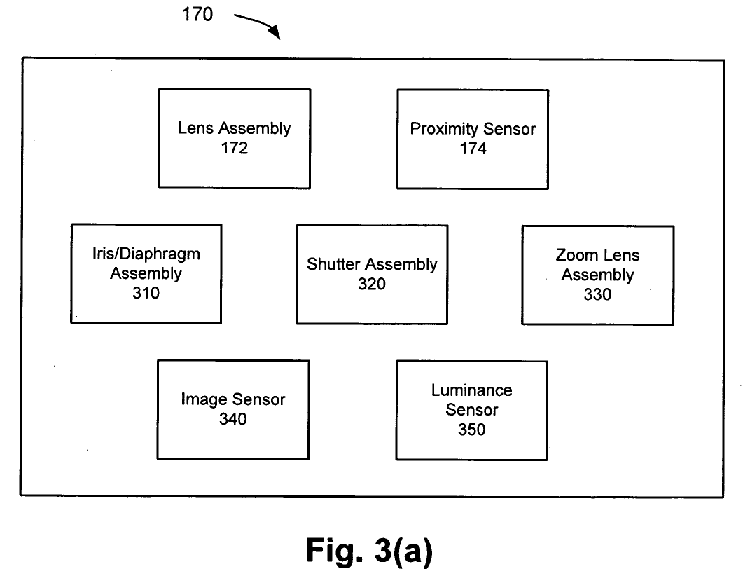

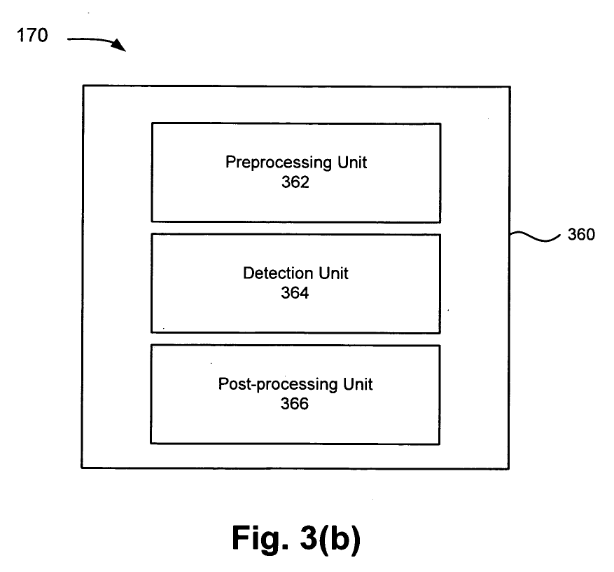

FIG. 3(a) is a diagram illustrating components of the exemplary camera depicted in FIG. 1(d). FIG. 3(a) illustrates lens assembly 172, proximity sensor 174, an iris/diaphragm assembly 310, a shutter assembly 320, a zoom lens assembly 330, an image sensor 340, and a luminance sensor 350. No further discussion relating to lens assembly 172 and proximity sensor 174 is provided in reference to FIG. 3(a).

Iris/diaphragm assembly 310 may include any component providing an aperture. Iris/diaphragm assembly 310 may be a thin, opaque, plastic structure with one or more apertures. This/diaphragm 310 may reside in a light path of lens assembly 172. Iris/diaphragm assembly 310 may include different size apertures. In such instances, iris/diaphragm assembly 310 may be adjusted, either manually or automatically, to provide a different size aperture. In other implementations, iris/diaphragm assembly 310 may provide only a single size aperture.

Shutter assembly 320 may include any component for regulating a period of time for light to pass through iris/diaphragm assembly 310. Shutter assembly 320 may include one or more shutters (e.g., a leaf or a blade). The leaf or blade may be made of, for example, a metal or a plastic. In one implementation, multiple leaves or blades may rotate about pins so as to overlap and form a circular pattern. In one implementation, shutter assembly 320 may reside within lens assembly 172 (e.g., a central shutter). In other implementations, shutter assembly 320 may reside in close proximity to image sensor 340 (e.g. a focal plane shutter). Shutter assembly 320 may include a timing mechanism to control a shutter speed. The shutter speed may be manually or automatically adjusted.

Zoom lens assembly 330 may include lens elements to provide magnification and focus of an image based on the relative position of the lens elements. Zoom lens assembly 330 may include fixed and/or movable lens elements. In one implementation, a movement of lens elements of zoom lens assembly 330 may be controlled by a servo mechanism that operates in cooperation with control unit 220.

Image sensor 340 may include any component to capture light. For example, image sensor 340 may be a charge-coupled device (CCD) sensor (e.g., a linear CCD image sensor, an interline CCD image sensor, a full-frame CCD image sensor, or a frame transfer CCD image sensor) or a Complementary Metal Oxide Semiconductor (CMOS) sensor. Image sensor 340 may include a grid of photo-sites corresponding to pixels to record light. A color filter array (CFA) (e.g., a Bayer color filter array) may be on image sensor 340. In other implementations, image sensor 340 may not include a color filter array. The size of image sensor 340 and the number and size of each pixel may vary depending on device 100. Image sensor 340 and/or control unit 220 may perform various image processing, such as color aliasing and filtering, edge detection, noise reduction, analog to digital conversion, interpolation, compression, white point correction, etc.

Luminance sensor 350 may include any component to sense the intensity of light (i.e., luminance). Luminance sensor 350 may provide luminance information to control unit 220 so as to determine whether to activate flash 176. For example, luminance sensor 350 may include an optical sensor integrated circuit (IC).

Although FIG. 3(a) illustrates exemplary components, in other implementations, device 100 may include fewer, additional, and/or different components than the exemplary components depicted in FIG. 3(a). For example, when device 100 is a film camera, image sensor 340 may be film. Additionally, it is to be understood that variations may exist among different devices as to the arrangement, placement, number, adjustability, shape, material, etc., relating to the exemplary components described above. In still other implementations, one or more exemplary components of device 100 may include the capabilities of one or more other components of device 100. For example, lens assembly 172 may include zoom lens assembly 330.

FIG. 3(b) is a diagram illustrating an exemplary face detection and tracking system of the exemplary camera. FIG. 3(b) illustrates a face detection and tracking system 360 that may include a preprocessing unit 362, a detection unit 364, and a post-processing unit 366. Face detection and tracking system 360 may include any logic for detecting and tracking one or more faces within an image. For example, face detection and tracking system 360 may include an application specific integrated circuit (ASIC) that includes one or more processors.

Preprocessing unit 362 may include any logic to process raw image data. For example, preprocessing unit 362 may perform input masking, image normalization, histogram equalization, and/or image sub-sampling techniques. Detection unit 364 may include any logic to detect a face within a region of an image and output coordinates corresponding to the region where face data is detected. For example, detection unit 364 may detect and analyze various facial features, such as skin color, shape, position of points (e.g., symmetry between eyes or ratio between mouth and eyes), etc. to identify a region of an image as containing face data. In other implementations, detection unit 364 may employ other types of face recognition techniques, such as smooth edge detection, boundary detection, and/or vertical and horizontal pattern recognition based on local, regional, and/or global area face descriptors corresponding to local, regional, and/or global area face features. In one implementation, detection unit 364 may scan an entire image for face data. In other implementations, detection unit 364 may scan select candidate regions of an image based on information provided by preprocessing unit 362 and/or post-processing unit 366.

Post-processing unit 366 may include any logic to provide tracking information to detection unit 364. For example, when camera 170 is capturing an image, such as a video, post-processing unit 366 may provide position prediction information of face data regions, for example, frame by frame, based on the coordinate information from detection unit 364. For example, when a subject is moving, post-processing unit 366 may calculate candidate face data regions based on previous coordinate information. Additionally, or alternatively, preprocessing unit 362 may perform various operations to the video feed, such as filtering, motion tracking and/or face localization to provide candidate regions to detection unit 364. In such instances, detection unit 364 may not need to scan the entire image frame to detect for a face data region. Face detection and tracking system 360 may perform face detection and tracking in real-time.

Although FIG. 3(b) illustrates exemplary components, in other implementations, device 100 may include fewer, additional, and/or different components than the exemplary components depicted in FIG. 3(b). For example, control unit 220 may perform one or more of the operations performed by face detection and tracking system 360. Further, it is to be understood that the development of face detection and tracking is ongoing, and other techniques not described herein may be employed. Additionally, or alternatively, in other implementations, device 100 may include other tracking and/or detecting systems that detect and/or track other parts of a human subject, such as a person's head, body, etc.

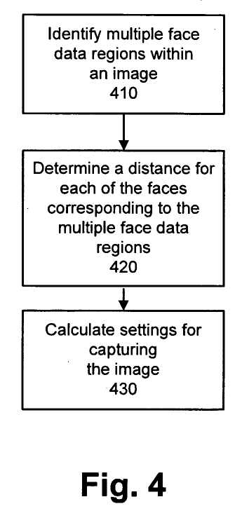

FIG. 4 is a flow diagram illustrating exemplary operations for performing multipoint autofocus for adjusting depth of field. In block 410, device 100 may automatically identify multiple face data regions within an image. For example, when device 100 operates in a camera mode for taking an image, display 150 may operate as a viewfinder and may display the image. This image data may be input to face detection and tracking system 360 to determine face data regions. The coordinates of the face data regions within an image may be sent to control unit 220 for further processing, as described below.

In block 420, device 100 may automatically determine a distance for each of the faces corresponding to the multiple face data regions. In one implementation, for example, device 100 may automatically adjust camera settings for each face based on coordinate information of face detection and tracking system 360. Device 100 may employ an active autofocus and/or a passive autofocus (e.g., phase detection or contrast measurement) approach. Control unit 220 may determine the camera settings that yield the highest degree of sharpness for each face.

In block 430, device 100 may automatically calculate camera settings for capturing the image. In one implementation, for example, device 100 may determine a DOF based on the distance information associated with each face data region. For example, the DOF may be calculated based on a difference distance between the nearest face and the farthest face. Since a DOF extends from one-third in front of a point of focus and two-thirds behind a point of focus, in one implementation, device 100 may calculate a point of focus based on the calculated DOF. For example, device 100 may determine the point of focus to be at a distance that is between a distance of the nearest face and a distance of the farthest face so that the front and back portions of the DOF extend to include the nearest and the farthest faces.

Given the variations that exist among cameras and the environment in which an image may be captured, additional considerations and calculations may be needed. For example, iris/diaphragm assembly 310 may not include an aperture size that can be adjusted, which may affect the calculation of the camera settings, such as the focus and aperture settings, for the image. Additionally, the size, the number of the pixels, the size of the pixels, and/or the light sensitivity of image sensor 340 may be factors in calculating the focus and/or the exposure settings for the image. That is, image sensor 340 provides for a certain degree of resolution and clarity. Thus, the calculation of the camera settings for the image may be based on the characteristics of one or more components of camera 170.

Further, the lighting conditions may effect the calculation of the camera settings for the image. For example, when low lighting conditions exist, amplification of the image signal may be needed, which may amplify unwanted noise and may degrade the quality of a captured image. Thus, for example, in one implementation, the calculated DOF may be decreased and the aperture size increased to allow for more light, and to reduce the amount of amplification and resulting noise. Additionally, or alternatively, when low lighting conditions are present, the shutter speed may be reduced and/or the light sensitivity of image sensor 340 may be increased to reduce an amount of amplification and corresponding noise level. Accordingly, it is to be understood that the lighting conditions together with characteristics of camera 170 may provide for adjusting the calculation of camera settings to allow a user of device 100 to capture an image of the highest possible quality.

### Exemplary Device

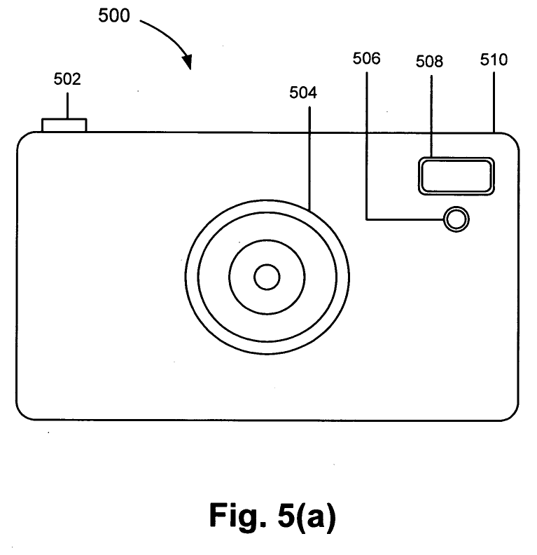

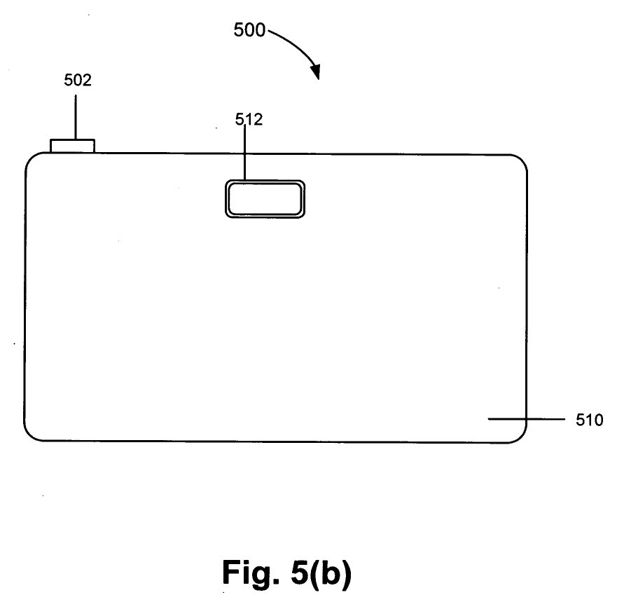

FIG. 5(a) and FIG. 5(b) are diagrams illustrating a front and rear view of external components of another exemplary device having multipoint autofocus for adjusting depth of field capability. In this implementation, device 500 may take the form of a camera, with or without additional communication functionality, such as the ability to make or receive telephone calls. As illustrated, device 500 may include a camera button 502, a lens assembly 504, a proximity sensor 506, a flash 508, a housing 510, and a viewfinder 512. Camera button 502, lens assembly 504, proximity sensor 506, flash 508, housing 510 and viewfinder 512 may include components that are similar to camera button 160, lens assembly 172, proximity sensor 174, flash 176, housing 105 and display 150 of device 100, and may operate similarly. Although not illustrated, device 500 may also include components that have been described with reference to FIGS. 3(a) and 3(b).

### EXAMPLE

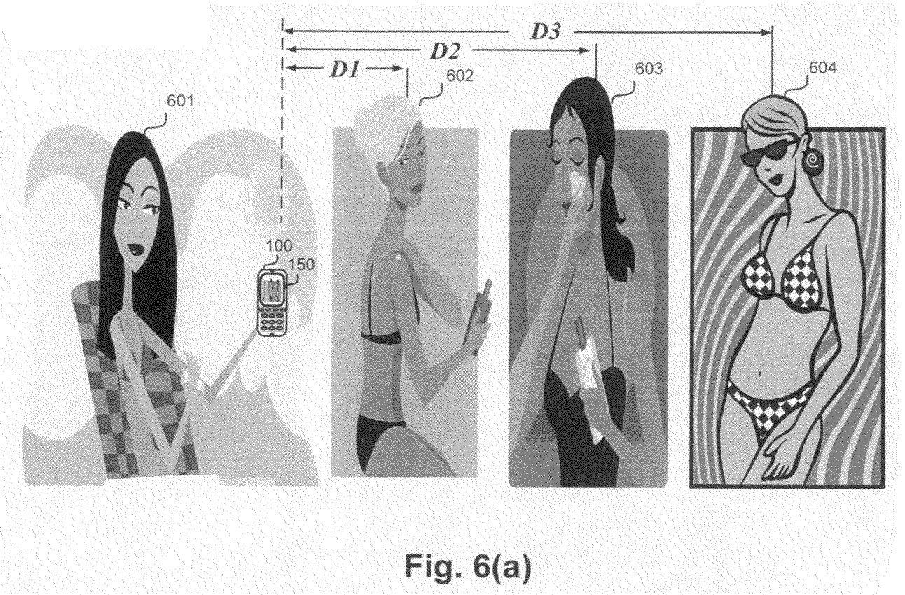

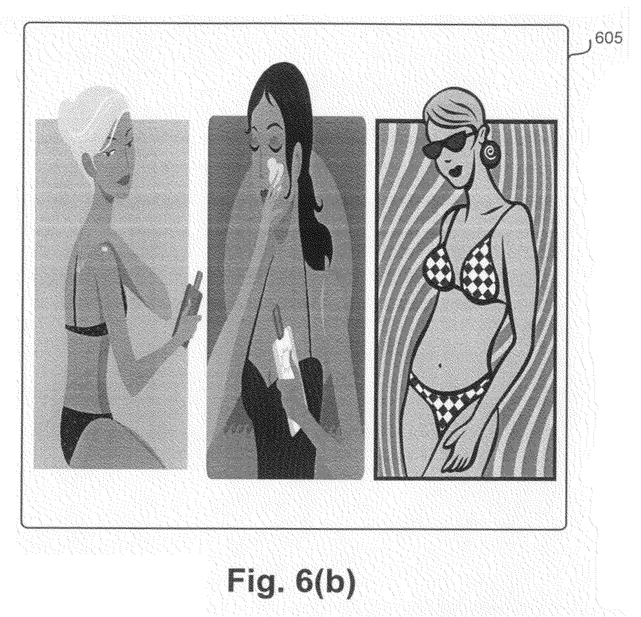

The following example illustrates exemplary processes of device 100 for performing multipoint autofocus for adjusting depth of field. As illustrated in FIG. 6(a), Susan 601, Jean 602, Betty 603, and Mary 604 are on the beach. Susan 601 has device 100 and wishes to take a picture of Jean 602, Betty 603, and Mary 604. Susan 601 operates device 100 in camera mode and points camera 170 at Jean 602, Betty 603, and Mary 604. Face detection and tracking system 360 may automatically detect face data regions corresponding to Jean 602, Betty 603, and Mary 604 based on image data of display 150.

Device 100 may automatically determine a distance for Jean 602, Betty 603, and Mary 604 based on the coordinate information from face detection and tracking system 360. For example, device 100 may determine a distance for Jean 602, Betty 603, and Mary 604 by auto-focusing on each of the faces. In this example, Jean 602, Betty 603, and Mary 604, are each at a different distance from device 100. For example, Jean 602 may be at a distance D1, Betty 603 may be at a distance D2, and Mary 604 may be at a distance D3, from device 100.

Device 100 may calculate a DOF based on distances D1, D2, and D3. For example, device 100 may determine that a DOF may be calculated based on a difference in distance between D1 and D3 (e.g., a distance D4). Device 100 may calculate a point of focus based on the calculated DOF distance D4, the camera settings associated with each distance (i.e., D1, D2, and D3), the characteristics of camera 170 components, and the lighting conditions. In this example, device 100 may adjust the DOF because the sun is very bright on the beach. Thus, for example, device 100 may reduce the size of the aperture of iris/diaphragm 310 and increase the light sensitivity of image sensor 340. As illustrated in FIG. 6(b), Susan 601 may press camera button 160 to capture a high quality image 605 of her friends.

### CONCLUSION

The foregoing description of implementations provides illustration, but is not intended to be exhaustive or to limit the implementations to the precise form disclosed. Modifications and variations are possible in light of the above teachings or may be acquired from practice of the teachings. For example, in other implementations, objects other than faces may be detected and/or tracked. For example, objects such as flowers or animals may be detected and/or tracked. In such an implementation, a user of device 100 may select from a menu system to identify the class of object that is to be detected, such as a human face, an animal, a plant, or any other type of object.

It should be emphasized that the term “comprises” or “comprising” when used in the specification is taken to specify the presence of stated features, integers, steps, or components but does not preclude the presence or addition of one or more other features, integers, steps, components, or groups thereof.

In addition, while a series of processes and/or acts have been described herein, the order of the processes and/or acts may be modified in other implementations. Further, non-dependent processes and/or acts may be performed in parallel.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

No element, act, or instruction used in the present application should be construed as critical or essential to the implementations described herein unless explicitly described as such. Also, as used herein, the article “a”, “an”, and “the” are intended to include one or more items. Where only one item is intended, the term “one” or similar language is used. Further, the phrase “based on” is intended to mean “based, at least in part, on” unless explicitly stated otherwise.

As used herein, the term “and/or” includes any and all combinations of one or more of the associated list items.

What is claimed is:

1. A device, comprising:
logic to capture an image;
logic to detect a plurality of faces in the image;
logic to calculate a distance associated with each face;
logic to calculate a depth of field based on the distance associated with each face; and
logic to calculate focus and exposure settings to capture the image based on the depth of field associated with the plurality of faces.

2. The device of claim 1, where the logic to calculate a distance comprises:
logic to determine coordinate information for each face in the image; and
logic to calculate a distance associated with each face based on the coordinate information of each face in the image.

3. The device of claim 1, where the logic to calculate a distance comprises:
logic to calculate a distance associated with each face based on a focus setting corresponding to each face.

4. The device of claim 1, where the logic to calculate a depth of field comprises:
logic to calculate a depth of field based on a distance corresponding to a nearest face and a distance corresponding to a farthest face.

5. The device of claim 4, where the logic to calculate a depth of field calculates a depth of field based on a difference distance between the nearest and the farthest faces.

6. The device of claim 1, where the logic to calculate focus and exposure settings comprises:
logic to calculate a focus point based on the depth of field.

7. A device, comprising:
a camera to capture an image;
logic to detect and track faces in the image;
logic to determine a distance associated with each face based on respective camera settings for each face;
logic to calculate a depth of field based on the distances associated with the faces; and
logic to determine focus and exposure settings to capture the image based on the depth of field and the respective camera settings for each face.

8. The device of claim 7, where the camera settings for each face are based on sensor size and pixel size of an image sensor.

9. The device of claim 7, where the camera settings for each face includes a focus point setting.

10. The device of claim 7, where the logic to determine focus and exposure settings comprises:
logic to calculate a focus point based on the depth of field.

11. The device of claim 7, where the logic to determine focus and exposure settings comprises:
logic to calculate an aperture size that provides a depth of field to include each focusing point associated with each face.

12. The device of claim 7, where the logic to determine focus and exposure settings comprises:
logic to calculate a focus point so that the depth of field includes each focusing point associated with each face.

13. The device of claim 7, where the logic to determine focus and exposure settings comprises:
logic to adjust the depth of field based on lighting conditions and characteristics of a camera component.

14. A device, comprising:
an image capturing component to capture an image;
an object recognition system to detect multiple objects of like classification in the image;
logic to determine a distance associated with each object of like classification based on auto-focusing on each object;
logic to calculate a depth of field based on the distances of the objects; and
logic to determine camera settings to capture the image based on the depth of field.

15. The device of claim 14, where the object recognition system detects and tracks at least one of human faces, plants, or animals.

16. The device of claim 14, where the logic to determine camera settings comprises:
logic to determine a focus point based on the depth of field.

17. The device of claim 14, where the logic to determine a distance comprises:
logic to determine coordinate information for each object in the image; and
logic to calculate a distance associated with each object based on coordinate information of an object in the image.

18. A device, comprising:
means for capturing an image;
means for detecting and tracking faces in the image;
means for calculating a distance between the device and each face in the image;
means for calculating a depth of field based on each distance associated with each face;
means for calculating a focus point based on the calculated depth of field; and
means for calculating camera settings for capturing the image of faces based on the calculated depth of field and the calculated focus point.

19. The device of claim 18, where the means for calculating a depth of field comprises:
means for determining a difference distance between a distance associated with a nearest face and a distance associated with a farthest face.

20. A method, comprising:
identifying face data regions in an image that correspond to human faces to be captured by a camera;
determining a distance between each human face and the camera;
calculating a depth of field based on the distances associated with the human faces; and
calculating a focus point to capture the human faces based on the calculated depth of field.

21. The method of claim 20, where calculating the depth of field comprises:
calculating a difference distance based on a distance of a human face that is closest to the camera and a distance of a human face that is farthest from the camera.
